(19) United States
(12) Patent Application Publication
(10) Pub. No.: US 2026/0299342 A1
(43) Pub. Date: Oct. 1, 2026

(54) IN-VEHICLE DISPLAY DEVICE

(71) Applicant: Panasonic Automotive Systems Co., Ltd., Kanagawa (JP)

(72) Inventors: Kaori KURITA, Kanagawa Ken (JP); Katsuyuki AWAZU, Kanagawa Ken (JP)

(73) Assignee: Panasonic Automotive Systems Co., Ltd., Kanagawa (JP)

(21) Appl. No.: 19/451,607

(22) Filed: Jan. 16, 2026

(30) Foreign Application Priority Data
Mar. 31, 2025 (JP) 2025-059685

(51) Int. Cl. G02F 1/1333; B60R 1/04; B60R 1/26; G02F 1/13357

(52) U.S. Cl. CPC G02F 1/133314; B60R 1/04; B60R 1/26; G02F 1/133385; G02F 1/133603; B60R 2300/20

(57) ABSTRACT

An in-vehicle display device according to one embodiment includes a display panel, a heat sink, a backlight LED, a support bracket, a pivot plate, a lever, and a controller. The heat sink is disposed to cover a back surface and a peripheral surface of the display panel. The backlight LED is disposed on an upper edge of the display panel along an upper end surface of the heat sink. The support bracket holds the display panel integrally with the heat sink. The pivot plate changes a relative position to the support bracket. The lever changes a posture of the pivot plate. The controller switches between an on state and an off state of the display panel to follow a change in the relative position of the support bracket.

### CROSS-REFERENCE TO RELATED APPLICATIONS

This application is based upon and claims the benefit of priority from Japanese Patent Application No. 2025-059685, filed on Mar. 31, 2025, the entire contents of which are incorporated herein by reference.

### FIELD

Embodiments described herein relate generally to an in-vehicle display device.

### BACKGROUND

In recent years, an electronic mirror system used in place of a rearview mirror in the related art and an in-vehicle display device with the electronic mirror system have been known. The electronic mirror system captures a rear image of a vehicle by using an image capturing device and displays the captured image.

In the related art (for example, Patent Literature: JP 2018-527245 A), a display device provided in a vehicle is disclosed, which serves to switch between a mode for displaying image data behind the vehicle and a mode for displaying a mirror image behind the vehicle.

Further improvement is desired in electronic mirror systems in the related art.

### SUMMARY

An in-vehicle display device according to one aspect of the present disclosure includes a display panel, a heat sink, a backlight LED, a support bracket, a pivot plate, a lever, and a controller. The heat sink is disposed to cover a back surface and a peripheral surface of the display panel. The backlight light-emitting-diode (LED) is disposed on an upper edge of the display panel along an upper end surface of the heat sink. The support bracket holds the display panel integrally with the heat sink. The pivot plate changes a relative position to the support bracket. The lever changes a posture of the pivot plate. The controller switches between an on state and an off state of the display panel to follow a change in the relative position of the support bracket.

### BRIEF DESCRIPTION OF THE DRAWINGS

FIG. 1 is a schematic configuration diagram of a vehicle in which a display system including a display device according to an embodiment is provided;

FIG. 2 is a perspective view illustrating an external configuration of the display device according to the embodiment;

FIG. 3 is a front view illustrating the external configuration of the display device according to the embodiment;

FIG. 4 is an exploded perspective view of the display device according to the embodiment;

FIG. 5 is a schematic configuration block diagram of a main substrate according to the embodiment; and

FIG. 6 is an operation processing flowchart at the time of starting the vehicle according to the embodiment.

### DETAILED DESCRIPTION

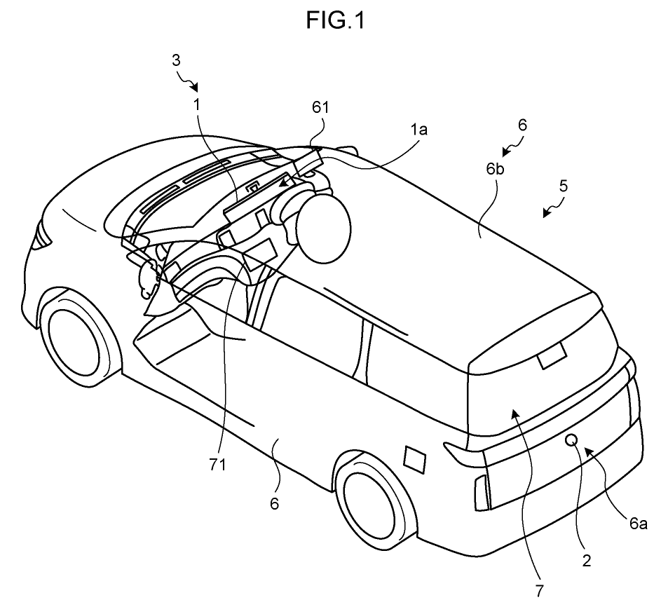

Hereinafter, a preferred embodiment will be described with reference to the drawings. FIG. 1 is a schematic configuration diagram of a vehicle in which a display system including a display device according to an embodiment is provided. As illustrated in FIG. 1, a display system 3 including a display device 1 (an example of the in-vehicle display device) according to the embodiment is provided in a vehicle 5. The display device 1 is configured as, for example, an electronic mirror, and the display system 3 is configured as an electronic mirror system. Thus, FIG. 1 is a diagram that illustrates the vehicle 5 in which the display system 3 is provided. The display system 3 includes the display device 1 and an image capturing device 2.

The image capturing device 2 is an in-vehicle camera mounted on the vehicle 5 and is installed outside or inside a vehicle body 6. In the present embodiment, the display system 3 is configured as an electronic mirror system. Therefore, the image capturing device 2 is installed in an end part on a rear side of the vehicle body 6 so as to capture an image of the rear. However, the image capturing device 2 may be installed in an end part near a door of the vehicle body 6 and capture an image of the side or may be installed at an end part on a front side of the vehicle body 6 and capture an image of the front.

The display device 1 is provided in a vehicle interior 7. The display device 1 functions as an electronic mirror and can display an image acquired by the image capturing device 2 on a front surface 1a. The display device 1 is configured to be switchable between a display mode and a mirror mode. The display mode is a mode in which a display panel in the display device 1 displays an image captured by the image capturing device 2 and the display device 1 functions as a display. The mirror mode is a mode in which the display panel in the display device 1 is turned off and the display device 1 functions as a mirror.

When the display device 1 serves as an electronic mirror for rear visual recognition, the display device 1 may be provided in the form of a rearview mirror, the front surface 1a may face the vehicle interior 7, and the shape of the front surface 1a may be the shape of a mirror surface of the rearview mirror. When the display device 1 serves as an electronic mirror for side visual recognition, the display device 1 may be provided in the form of a door mirror (for example, a door mirror 61), the front surface 1a may face the rear of the vehicle body 6, and the shape of a front surface 2a may be the shape of a mirror surface of the door mirror. When the display device 1 serves as an electronic mirror for front visual recognition, the display device 1 may be provided in the form of an in-vehicle display device (for example, a display device 71) or may be provided such that the front surface 1a faces the vehicle interior 7 and the shape of the front surface 2a is the shape of the display unit of the display panel that is the display device.

In the example of FIG. 1, the image capturing device 2 is installed in an end part 6a on the rear side of the vehicle body 6, and the display device 1 is applied to an electronic mirror system for rear visual recognition. The electronic mirror system for rear visual recognition is also referred to as an electronic rearview mirror. The image capturing device 2 acquires an image behind the vehicle body. The display device 1 can display an image behind the vehicle body captured by the image capturing device 2.

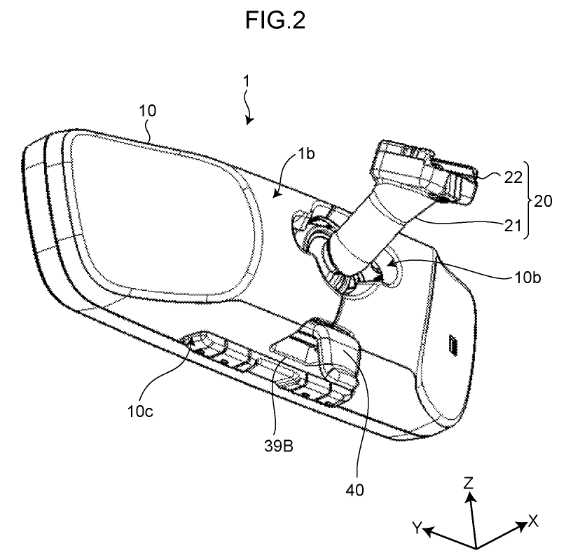

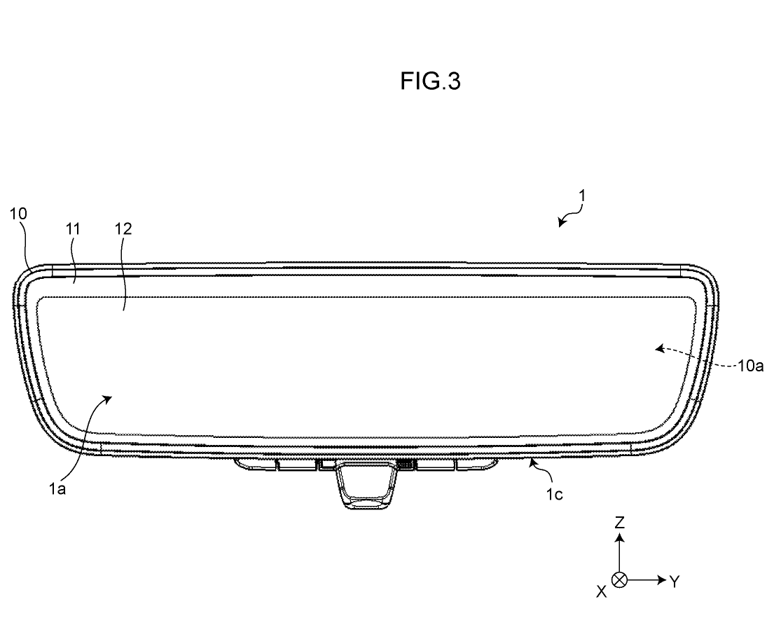

FIG. 2 is a perspective view illustrating an external configuration of the display device 1. FIG. 3 is a front view illustrating the external configuration of the display device 1.

The display device 1 may have a back surface 1b on the side opposite to the front surface 1a and may be fixed to the vehicle body of the vehicle 5 via a fixing member 20 on the back surface 1b side. The display device 1 includes a housing 10, a transmission reflection part 11, and a display panel 12.

The housing 10 has a substantially rectangular parallelepiped external shape. Hereinafter, as illustrated in FIGS. 2 and 3, a direction perpendicular to the front surface 1a of the display device 1 is defined as an X direction, a longitudinal direction of the housing 10 is defined as a Y direction, and a direction perpendicular to the X direction and the Y direction is defined as a Z direction.

The housing 10 has an opening 10a on the -X side, an opening 10b on the +X side, and an opening 10c on the -Z side.

One end of an arm 21 of the fixing member 20 is rotatably inserted into the opening 10b. The other end of the arm 21 is connected to a mounting member 22 in the fixing member 20. The mounting member 22 may be provided inside the vehicle body 6. Accordingly, the housing 10 can be fixed to the vehicle body 6.

The transmission reflection part 11 is disposed on the -X side of the display panel 12 and is fixed to the housing 10 from the -X side. The transmission reflection part 11 extends in a YZ direction in a plate shape and has a substantially rectangular shape or a substantially inverted isosceles trapezoidal shape in the YZ plane view. In the transmission reflection part 11, corners of the substantially rectangular shape or the substantially inverted isosceles trapezoidal shape may be rounded. The transmission reflection part 11 has a YZ dimension corresponding to the opening 10a. The Y width of the transmission reflection part 11 is slightly larger than the Y width of the opening 10a. The Z width of the transmission reflection part 11 is slightly larger than the Z width of the opening 10a. Thus, the transmission reflection part 11 can close the opening 10a from the -X side.

The display panel 12 is disposed on the +X side of the transmission reflection part 11 and is accommodated in the housing 10. The display panel 12 extends in the YZ direction in a plate shape and has a substantially rectangular shape in the YZ plane view. The display panel 12 has a YZ dimension corresponding to the opening 10a. The Y width of the display panel 12 is slightly larger than the Y width of the opening 10a. The Z width of the display panel 12 is slightly larger than the Z width of the opening 10a. Thus, the display panel 12 can close the opening 10a from the +X side.

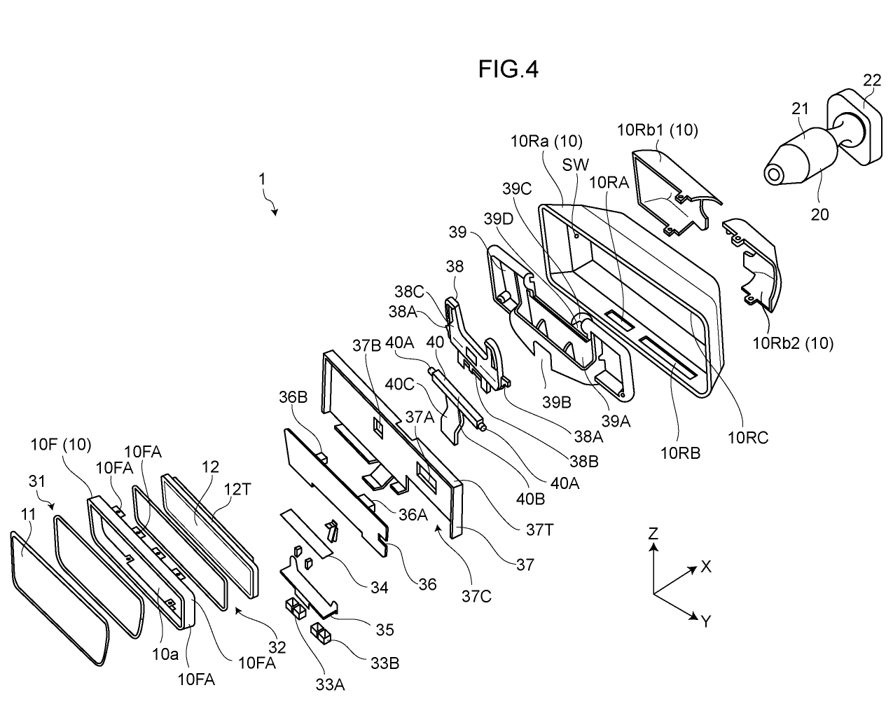

FIG. 4 is an exploded perspective view of the in-vehicle display device. The transmission reflection part 11 is fixed to the front surface side of a front frame 10F configuring the housing 10 by adhesive members 31 (in FIG. 4, four members) such as a double-sided tape on a peripheral edge part. On the +X side of the front frame 10F, engagement protrusions 10FA are provided.

Moreover, on the +X side surface of the front frame 10F, the display panel 12 configured as an LCD module is fixed to a peripheral edge part of the surface on the -X side by using adhesive members 32 (in FIG. 3, four members) such as a double-sided tape.

On the -Z side (lower side) of the display panel 12, button switches 33A and 33B are supported by a button holder 35 and protrude in a state of being mounted on a button substrate 34 so as to be operable from the surface side of the in-vehicle display device.

A main substrate 36 on which the button substrate 34 is erected is provided on the +X side of the display panel 12. According to this configuration, a space for providing the button substrate 34 can be reduced, and light-emitting-diodes (LEDs) for button illumination and the like can be easily arranged on the button substrate 34.

On the +X side of the main substrate 36, a first connector 36A for connecting a control cable and a second connector 36B for connecting a power cable are provided. Moreover, a heat sink 37 formed with metal is attached to the main substrate 36 in a thermally coupled state. More specifically, the heat sink 37 is formed with an iron-based metal sheet or an aluminum-based metal sheet.

The shape of the heat sink 37 is left-right asymmetric. Therefore, the button substrate 34 can be easily avoided, and space saving can be achieved. The heat sink 37 is provided so as to contact with most of the peripheral surface of the display panel 12 while being attached to the main substrate 36.

A backlight LED unit (not illustrated) including a plurality of backlight LEDs is provided on a back surface (surface on the -Z side) of an upper end surface 37T (+Z side end surface) of the heat sink 37. The backlight LED unit is configured to perform illumination as a backlight from a back surface side (-Z side) of the backlight LED unit by a light guide panel (not illustrated) arranged on the display panel 12 on the -Z side (lower side) of the backlight LED unit. The heat sink 37 and the backlight LED unit are in direct contact with each other or are in contact with each other via a heat conduction member to be thermally coupled with each other so that heat generated in the backlight LED unit can be efficiently dissipated. Therefore, it is possible to reliably cool the plurality of LEDs configuring the backlight LED unit.

The heat sink 37 is provided with an opening 37A through which the first connector 36A is inserted, an opening 37B through which the second connector 36B is inserted, and a notch 37C for arranging the button switches 33A and 33B and the button substrate 34. In the present embodiment, the notch 37C is provided at the lower right of the heat sink 37. In other words, the button substrate 34 is erected from the lower right of the main substrate 36. As a result, when the display device 1 is viewed from the front, the button switch 33A and the button switch 33B are arranged on the right side of the center on the lower side of the display device 1. As a result, the driver can easily operate the button switch 33A and the button switch 33B without interfering with a lever operator 40C (described below) provided in the center on the lower side of the display device 1.

Moreover, the heat sink 37 functions as a shield for preventing interference between electromagnetic noise generated in the main substrate 36 and electromagnetic noise reaching the main substrate 36 from the surroundings.

A pivot plate 38, a support bracket 39, and a lever 40 are arranged on the +X side of the heat sink 37. The heat sink 37 is fixed to the support bracket 39 by screwing a screw (not illustrated). With this configuration, a component that moves integrally with the support bracket 39 in an interlocking manner (for example, the display panel 12) can be appropriately fixed.

The lever 40 is stored on the most -Z side in a storage part 39A of the support bracket 39 so as to be rotatable about a rotary projection 40A as a rotary axis. The lever operator 40C of the lever 40 protrudes from an opening 39B of the support bracket 39.

Further, the pivot plate 38 is rotatably stored in the storage part 39A of the support bracket 39 with a rotary projection 38A as a rotary axis. A -Z direction end part 38B of the pivot plate 38 abuts on an abutment part 40B of a +Z side end part of the lever 40.

On the +X side of the support bracket 39, a ball member 39C configuring a universal ball joint mechanism is supported by a shaft member 39D protruding from a surface on the +X side of the support bracket 39 in cooperation with the fixing member 20. The peripheral surface of the arm 21 of the fixing member 20 configures a stay made of sheet metal, and a holder that is configured to press the ball member 39C toward the center of the ball when the ball member 39C is regarded as the ball and rotatably holds the ball member 39C is provided inside the stay.

On the +X side of the support bracket 39, a rear frame 10R configuring the housing 10 is provided. The rear frame 10R is provided with an opening 10RA through which the lever 40 is inserted and an opening 10RB through which the button switches 33A and 33B are inserted. The engagement protrusions 10FA that are provided in the front frame 10F are engaged with the rear frame 10R.

On the +X side of the rear frame 10R, a rectangular opening 10RC is provided. The ball member 39C supported by the shaft member 39D configuring the universal ball joint mechanism is grasped by the fixing member 20 so that the shaft member 39D can be in a state of being supported in a swingable manner. In the present embodiment, an example is provided in which the entire +X side surface of the rear frame 10R is the rectangular opening 10RC, but the present invention is not limited thereto. A back surface may be provided on the +X side of the rear frame 10R, and an opening having such a size that the ball member 39C and the fixing member 20 can be arranged may be provided.

Part of the fixing member 20 on the -X side is sandwiched from the Y direction by a first cover member 10Rb1 and a second cover member 10Rb2 configuring part of the housing 10, and the first cover member 10Rb1 and the second cover member 10Rb2 are provided so as to close the rectangular opening 10RC by engagement protrusions 10RbA.

As a result, the display device 1 is in a state as illustrated in FIGS. 2 and 3, and is provided in the vehicle 5 as illustrated in FIG. 1.

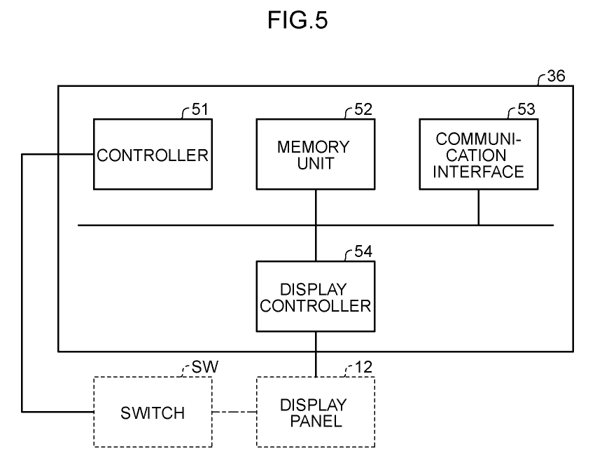

A schematic configuration of the main substrate 36 will be described. FIG. 5 is a schematic configuration block diagram of the main substrate. The main substrate 36 is provided with a plurality of hardware elements functioning as a microcomputer. The hardware elements includes, for example, a controller 51 having at least one processor, a memory unit 52 including as a ROM, a RAM, etc., a communication interface 53 performing communication with an external device such as an in-vehicle ECU, and a display controller 54 performing display control of the display panel 12.

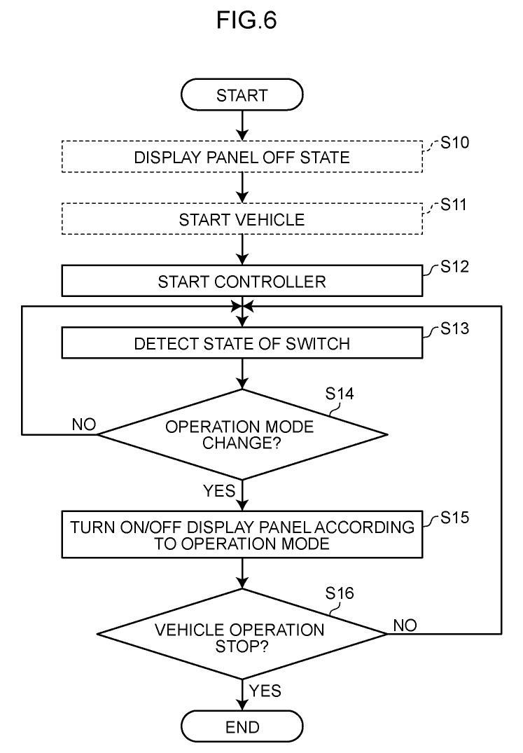

Next, an operation at the time of starting the vehicle according to the embodiment will be described. FIG. 6 is an operation processing flowchart at the time of starting the vehicle. In the following description, an operation mode of the display device 1 includes a display mode in which an image captured by the image capturing device 2 is displayed on the display panel 12 and a mirror mode in which the display panel 12 is turned off and performs optical reflection to cause the display device 1 to function as an optical mirror, and the operation mode is switched by the operation of the lever operator 40C.

A switch SW (for example, a microswitch) for detecting an orientation of the support bracket 39 is provided in the display device 1 (in the example of FIG. 4, in the rear frame 10R). The switch SW is turned on when the support bracket 39 faces the ceiling direction (substantially +Z direction) of the vehicle and is turned off when the support bracket 39 faces the rear (substantially -X direction) of the vehicle. The on/off state of the switch SW can be reversed to the above as long as the orientation of the support bracket 39 can be identified. Also, an arrangement position of the switch SW may be any position as long as the orientation of the support bracket 39 can be identified.

It is assumed that power is not supplied to the display device 1 in the initial state (step S10). In this state, when the vehicle 5 is started (step S11) and power is supplied, the controller 51 is booted up (step S12). Then, a predetermined initial startup operation including a check of the memory unit 52, a program operation check, and an operation check of the communication interface 53 is completed, and the state transitions to a normal operation state. In parallel with this operation, power is supplied to the display device 1.

Subsequently, the controller 51 detects the state of the switch SW (step S13) and determines whether the operation mode of the display device 1 is changed (step S14). In response to determining in step S14 that the operation mode is changed (step S14; Yes), the display panel 12 is turned on/off to follow the operation mode (step S15).

More specifically, in this state, when the user operates the lever operator 40C, the lever 40 rotates in a plane parallel to the Z-X plane with the rotary projection 40A as the rotary axis. Then, the pivot plate 38 abutting on the lever 40 is rotated in a direction opposite to the lever 40 in a plane parallel to the Z-X plane with the rotary projection 38A as the rotary axis. As a result, the support bracket 39 in which the pivot plate 38 is stored rotates in the same direction as the lever 40 in a plane parallel to the Z-X plane in the housing 10.

Moreover, in a case that the user sets the operation mode of the display device 1 to the display mode by pulling the lever operator 40C toward the front, in other words, moving the lever operator 40C in the -X direction, the support bracket 39 rotates so as to face upward. As a result, the switch SW for identifying the orientation of the support bracket 39 is turned on. Therefore, the controller 51 sets the operation mode of the display device 1 to the display mode (step S15).

Note that the reason for the support bracket 39 being directed upward is to prevent the image in which the landscape behind the vehicle is reflected and displayed on the transmission reflection part 11 from becoming difficult to see, and the ceiling of the vehicle is reflected on the transmission reflection part 11.

Meanwhile, when the operation mode of the display device 1 is set to the mirror mode, the user performs an operation of pushing the lever operator 40C, in other words, moving the lever operator in the +X direction. As a result, the support bracket 39 rotates to face perpendicularly to the -X direction. The switch for identifying the orientation of the support bracket 39 is turned off. Therefore, the controller 51 sets the operation mode of the display device 1 to the mirror mode (step S15).

In this case, the reason for the support bracket 39 being directed perpendicular to the -X direction is that the landscape behind the vehicle can be reflected by the transmission reflection part 11 and visually recognized by the user.

By rotation of the support bracket 39 in the housing 10, the display panel 12 also rotates via the heat sink 37 fixed to the support bracket 39, and the orientation is adjusted according to the operation mode of the display device 1. Thereafter, the controller 51 determines whether the vehicle operation has stopped (step S16).

When the vehicle operation has stopped (step S16; Yes), the process ends. If the vehicle operation is not stopped (step S16; No), the process proceeds to step S13 again, and the above-described process is repeated below.

As described above, by the rotation operation of the lever 40, the relative position of the pivot plate 38 with respect to the support bracket 39 is changed and thereby the angles of the transmission reflection part 11 and the display panel 12 are changed. Therefore, the orientations of the transmission reflection part 11 and the display panel 12 can be easily adjusted to the optimum orientations suitable for the operation mode of the display device 1. In addition, the display panel 12 is turned on and displayed only by performing the rotation operation of the lever 40. Therefore, even in a state where an image is not displayed on the display panel 12, the image can be immediately displayed, and the labor of the user can be reduced.

In addition, even when the backlight LEDs configuring a backlight LED unit 12A becomes an on state by turning-on of the display panel 12 and heat is generated, heat can be easily exhausted due to part of the heat sink 37 being disposed on the +Z side of the backlight LED unit 12A.

In the above description, the pivot plate 38 and the heat sink 37 are configured as separate members, but the pivot plate 38 and the heat sink 37 can be integrally configured as one member by metal. As a result, the manufacturing cost can be reduced by reducing the number of components, and also the exhaust heat effect can be further enhanced. In the above description, the controller 51 detects the state of the switch that detects the orientation of the support bracket 39, determines whether the operation mode of the display device 1 has been changed, and turns on/off the display panel 12 in accordance with the operation mode. However, the present invention is not limited thereto. For example, an on/off switch may be provided in the display panel 12. In this case, the operation mode of the display device 1 may be changed by switching of the on/off switch of the display panel 12 due to change in the orientation of the support bracket 39. Specifically, a switch SW1 is provided on the back surface of the display panel 12, and a state in which the pivot plate 38 is in contact with the switch SW1 and a state in which the pivot plate is not in contact with the switch SW1 are switched by changing the orientation of the support bracket 39. When, for example, the user pulls the lever operator 40C toward the front, the support bracket 39 rotates so as to face upward. As a result, the pivot plate 38 comes into contact with the switch SW1, and the display panel 12 is turned on. In other words, the display device 1 enters the display mode. Inversely, when the user pushes the lever operator 40C, the support bracket 39 rotates to face perpendicularly to the -X direction. Consequently, the pivot plate 38 is not in contact with the switch SW1, and the display panel 12 is turned off. In other words, the display device 1 enters the mirror mode. The display panel 12 may be turned on in a state where the pivot plate 38 is not in contact with the switch SW1, and the display panel 12 may be turned off in a state where the pivot plate 38 is in contact with the switch SW1.

In the above description, part of the heat sink 37 is disposed on the +Z side of the backlight LED unit 12A having backlight LEDs. Alternatively, a backlight LED unit of a direct type (illuminating from the +X direction of the display panel 12) can be used as the backlight LED unit 12A.

According to this configuration, local dimming (by partly changing the brightness of the LED, the contrast of the display image is increased to be easily viewed, or a video with realistic feeling is displayed) can be performed or the entire display panel can be made to have similar brightness.

In the above description, the liquid crystal panel display is used as the display panel 12, whereas the display panel 12 can be implemented by an organic EL panel display. According to this configuration, the entire display device 1 can be thinned, namely, the electronic mirror can be thinned, and installation flexibility is improved.

While certain embodiments have been described, these embodiments have been presented by way of example only, and are not intended to limit the scope of the inventions. Indeed, the novel methods and systems described herein may be embodied in a variety of other forms; furthermore, various omissions, substitutions, and changes in the form of the methods and systems described herein may be made without departing from the spirit of the inventions. The accompanying claims and their equivalents are intended to cover such forms or modifications as would fall within the scope and spirit of the inventions.

What is claimed is:

1. An in-vehicle display device comprising:
a display panel;
a heat sink disposed to cover a back surface and a peripheral surface of the display panel;
a backlight light-emitting-diode (LED) disposed on an upper edge of the display panel along an upper end surface of the heat sink;
a support bracket that holds the display panel integrally with the heat sink;
a pivot plate that changes a relative position to the support bracket;
a lever that changes a posture of the pivot plate; and
a controller that switches between an on state and an off state of the display panel to follow a change in the relative position of the support bracket.

2. The in-vehicle display device according to claim 1, further comprising a switch that identifies an orientation of the support bracket,
wherein the controller performs switching between the on state and the off state of the display panel to follow the orientation of the support bracket identified by the switch.

3. The in-vehicle display device according to claim 1, wherein
the pivot plate is stored and held in a storage of the support bracket rotatably about a first rotary axis as a rotation center,
the lever is provided to abut on the pivot plate, and
the lever is stored in the storage of the support bracket while allowing the pivot plate to rotate about the first rotary axis by the lever rotating about a second rotary axis different from the first rotary axis.

4. The in-vehicle display device according to claim 2, wherein
the pivot plate is stored and held in a storage of the support bracket rotatably about a first rotary axis as a rotation center,
the lever is provided to abut on the pivot plate, and
the lever is stored in the storage of the support bracket while allowing the pivot plate to rotate about the first rotary axis by the lever rotating about a second rotary axis different from the first rotary axis.

5. The in-vehicle display device according to claim 1, wherein the backlight LED is provided to abut on the heat sink directly or abut via a heat transfer member.

6. The in-vehicle display device according to claim 2, wherein the backlight LED is provided to abut on the heat sink directly or abut via a heat transfer member.

7. The in-vehicle display device according to claim 3, wherein the backlight LED is provided to abut on the heat sink directly or abut via a heat transfer member.

8. The in-vehicle display device according to claim 1, further comprising a main substrate on which a plurality of hardware elements functioning as a microcomputer is provided, the elements including the controller and a display controller serving to perform display control of the display panel.

9. The in-vehicle display device according to claim 8, wherein
the main substrate is provided between the display panel and the heat sink, and
the heat sink is thermally coupled to the main substrate.

10. The in-vehicle display device according to claim 1, wherein the heat sink is fixed to the support bracket.

11. The in-vehicle display device according to claim 1, wherein the heat sink has an asymmetrical shape.

12. The in-vehicle display device according to claim 2, further comprising a main substrate on which a plurality of hardware elements functioning as a microcomputer is provided, the elements including the controller and a display controller serving to perform display control of the display panel.

13. The in-vehicle display device according to claim 12, wherein
the main substrate is provided between the display panel and the heat sink, and
the heat sink is thermally coupled to the main substrate.

14. The in-vehicle display device according to claim 2, wherein the heat sink is fixed to the support bracket.

15. The in-vehicle display device according to claim 2, wherein the heat sink has an asymmetrical shape.
